(19) United States
(12) Patent Application Publication
(10) Pub. No.: US 2020/0307482 A1
(43) Pub. Date: Oct. 1, 2020

(54) STRADDLE-TYPE VEHICLE INFORMATION PROCESSOR AND STRADDLE-TYPE VEHICLE INFORMATION PROCESSING METHOD

(71) Applicant: Robert Bosch GmbH, Stuttgart (DE)

(72) Inventor: Keiichiro Fukuzawa, Kanagawa (JP)

(21) Appl. No.: 16/753,942

(22) PCT Filed: Sep. 13, 2018
(86) PCT No.: PCT/IB2018/056995

§ 371 Date: Apr. 6, 2020

(30) Foreign Application Priority Data
Oct. 10, 2017 (JP) 2017-197186

(51) Int. Cl. B60R 21/0132; B62J 27/00; B60R 21/017

(52) U.S. Cl. CPC B60R 21/0132; B60R 2021/0088; B60R 21/017; B62J 27/00

(57) ABSTRACT

To obtain a straddle-type vehicle information processor and a straddle-type vehicle information processing method capable of recognizing that a straddle-type vehicle has crashed during travel with a high degree of accuracy at appropriate timing to contribute to improvement in occupant safety.

A straddle-type vehicle information processor 10 includes: a travel state information acquisition section 11 that acquires, as information related to a travel state of a straddle-type vehicle 1, a physical quantity set that is configured to include at least two types of physical quantities; a crash recognition section 12 that acquires a Mahalanobis distance with respect to a referred sample group of the physical quantity set and determines whether the crash has occurred on the basis of a relationship between the Mahalanobis distance and a reference value; and an output section 13 that makes output corresponding to the recognition of the crash by the crash recognition section 12.

### BACKGROUND OF THE INVENTION

The present invention relates to an information processor and an information processing method for recognizing that a straddle-type vehicle has crashed during travel.

As a conventional vehicle information processor, a vehicle information processor that includes a travel state information acquisition section, a crash recognition section, and an output section has been available. The travel state information acquisition section acquires information related to a travel state of a vehicle, the crash recognition section recognizes that the vehicle has crashed during travel on the basis of the information acquired by the travel state information acquisition section, and the output section makes output corresponding to the recognition of the crash by the crash recognition section. As the information related to the travel state, the travel state information acquisition section acquires acceleration that is generated in the vehicle during the travel. The crash recognition section recognizes that the vehicle has crashed during the travel in the case where the acceleration exceeds a threshold value (for example, see JP-A-2009-290789).

### SUMMARY OF THE INVENTION

A target of the conventional vehicle information processor is a vehicle with relatively high travel stability such as an automobile or a track, that is, a vehicle in which a change in the acceleration generated during the travel is relatively small. In addition, a target of the crash recognition by the conventional vehicle information processor is a vehicle with relatively high occupant safety such as the automobile or the track. Accordingly, in the case where the conventional vehicle information processor is used as a straddle-type vehicle information processor for a purpose of recognizing that a straddle-type vehicle has crashed during travel, a frequency of the erroneous recognition that the straddle-type vehicle has crashed is increased due to the relatively significant change in the acceleration generated during the travel. In addition, in the case where the threshold value is set high so as to suppress such an increase, a delay occurs to the recognition of the crash despite a fact that the occupant safety is relatively low.

The present invention has been made with the above-described problems as the background, and therefore obtains a straddle-type vehicle information processor and a straddle-type vehicle information processing method capable of recognizing that a straddle-type vehicle has crashed during travel with a high degree of accuracy at appropriate timing to contribute to improvement in occupant safety.

The present invention is a straddle-type vehicle information processor that includes: a travel state information acquisition section that acquires information related to a travel state of a straddle-type vehicle; a crash recognition section that recognizes that the straddle-type vehicle has crashed during travel on the basis of the information acquired by the travel state information acquisition section; and an output section that makes output corresponding to the recognition of the crash by the crash recognition section. The travel state information acquisition section acquires, as the information, a physical quantity set that is configured to include at least two types of physical quantities. The crash recognition section acquires a Mahalanobis distance with respect to a referred sample group of the physical quantity set, which is acquired by the travel state information acquisition section, and determines whether the crash has occurred on the basis of a relationship between said Mahalanobis distance and a reference value.

The present invention is a straddle-type vehicle information processing method that includes: a travel state information acquisition step of acquiring information related to a travel state of a straddle-type vehicle; a crash recognition step of recognizing that the straddle-type vehicle has crashed during travel on the basis of the information acquired in the travel state information acquisition step; and an output step of making output corresponding to the recognition of the crash in the crash recognition step. In the travel state information acquisition step, a physical quantity set that is configured to include at least two types of physical quantities is acquired as the information. In the crash recognition step, a Mahalanobis distance is acquired with respect to a referred sample group of the physical quantity set acquired in the travel state information acquisition step, and it is determined whether the crash has occurred on the basis of a relationship between said Mahalanobis distance and a reference value.

In the straddle-type vehicle information processor and the straddle-type vehicle information processing method according to the present invention, the physical quantity set, which is configured to include the at least two types of the physical quantities, is acquired as the information related to the travel state of the straddle-type vehicle, the Mahalanobis distance is acquired with respect to the referred sample group of the physical quantity set, and it is determined whether the crash has occurred on the basis of the relationship between the Mahalanobis distance and the reference value. That is, it is determined whether the crash has occurred in consideration of dispersion states of the at least two types of the physical quantities in a no-crash state. Accordingly, even in the case where acceleration of the straddle-type vehicle is abruptly increased during the travel, such erroneous recognition that the straddle-type vehicle has crashed can be prevented. In addition, it is possible to recognize that the straddle-type vehicle has crashed at a stage before the acceleration is extremely increased. Therefore, the present invention can contribute to improvement in occupant safety.

### BRIEF DESCRIPTION OF THE DRAWINGS

FIG. 1 is a diagram of an exemplary system configuration of a straddle-type vehicle information processor according to an embodiment of the present invention.

FIG. 2 is a flowchart of an exemplary operation of the straddle-type vehicle information processor according to the embodiment of the present invention.

FIG. 3 is a graph illustrating action in a crash recognition step executed by a crash recognition section of the straddle-type vehicle information processor according to the embodiment of the present invention.

FIG. 4 is a graph illustrating the action in the crash recognition step executed by the crash recognition section of the straddle-type vehicle information processor according to the embodiment of the present invention.

### DETAILED DESCRIPTION

A description will hereinafter be made on a straddle-type vehicle information processor and a straddle-type vehicle information processing method according to the present invention by using the drawings. Note that a configuration, an operation, and the like, which will be described below, constitute merely one example and each of the straddle-type vehicle information processor and the straddle-type vehicle information processing method according to the present invention is not limited to a case with such a configuration, such an operation, and the like.

Embodiment

A description will hereinafter be made on a straddle-type vehicle information processor according to an embodiment.

### <Configuration of Straddle-Type Vehicle Information Processor>

A description will be made on a configuration of the straddle-type vehicle information processor according to the embodiment.

FIG. 1 is a diagram of an exemplary system configuration of the straddle-type vehicle information processor according to the embodiment of the present invention.

As illustrated in FIG. 1, a straddle-type vehicle information processor 10 includes a travel state information acquisition section 11, a crash recognition section 12, and an output section 13. The straddle-type vehicle information processor 10 is mounted on a straddle-type vehicle 1. The straddle-type vehicle 1 means a type of a vehicle on which an occupant is seated in a manner to straddle. Examples of the straddle-type vehicle 1 are a motorcycle (a two-wheeled motor vehicle, a three-wheeled motor vehicle, and the like) and an all-terrain vehicle.

A travel state information sensor 20 that is mounted on the straddle-type vehicle 1 is connected to the straddle-type vehicle information processor 10. When the travel state information acquisition section 11 receives output of the travel state information sensor 20, the travel state information acquisition section 11 acquires information related to a travel state of the straddle-type vehicle 1. As the information related to the travel state of the straddle-type vehicle 1, the travel state information acquisition section 11 continuously acquires a physical quantity set s that is configured to include at least two types of physical quantities at a time point.

The travel state information sensor 20 is an inertial measurement unit (IMU) that includes a three-axis gyroscope sensor and a three-directional acceleration sensor, for example. In such a case, the travel state information acquisition section 11 acquires, as the information related to the travel state of the straddle-type vehicle 1, the physical quantity set s that is configured to include the two types or more of the physical quantities among an angular velocity and acceleration generated in the straddle-type vehicle 1 during travel (that is, six types of the physical quantities). The travel state information acquisition section 11 may receive the angular velocity itself from the travel state information sensor 20 or may receive, as the angular velocity, another physical quantity that can substantially be converted to the angular velocity. Alternatively, the travel state information acquisition section 11 may receive the acceleration itself from the travel state information sensor 20 or may receive, as the acceleration, another physical quantity that can substantially be converted to the acceleration.

The crash recognition section 12 acquires a Mahalanobis distance MHD with respect to a referred sample group of the physical quantity set s that is acquired by the travel state information acquisition section 11, and determines whether the straddle-type vehicle 1 has crashed on the basis of a relationship between the Mahalanobis distance MEM and a reference value Th. The referred sample group is referred data that is configured to include plural referred physical quantity sets S (that is, the physical quantity sets, each of which is referred and is configured to include the same types of the physical quantities as the physical quantity set s). The referred sample group may be input and stored in advance (for example, upon shipment), or may be generated from the plural physical quantity sets s that have been acquired by the travel state information acquisition section 11 in the past. In addition, the crash recognition section 12 may acquire the Mahalanobis distance MHD itself or may acquire, as the Mahalanobis distance MHD, another parameter that can substantially be converted to the Mahalanobis distance MEM.

The output section 13 outputs a trigger signal to an execution device 30 when the crash recognition section 12 recognizes that the straddle-type vehicle 1 has crashed. When receiving the trigger signal, the execution device 30 performs an operation to inform a rescue facility that the straddle-type vehicle 1 has crashed, for example. In addition, when receiving the trigger signal, the execution device 30 performs an operation to protect the occupant of the straddle-type vehicle 1 (for example, an operation to activate an airbag, or the like), for example.

In the straddle-type vehicle information processor 10, the sections may collectively be accommodated in a single casing, or each of the sections may be provided in a separate casing. In addition, the straddle-type vehicle information processor 10 may be incorporated in the execution device 30 or may not be incorporated in the execution device 30. Furthermore, the straddle-type vehicle information processor 10 may partially or entirely be constructed of a microcomputer, a microprocessor unit, or the like, may be constructed of a member in which firmware and the like can be updated, or may be a program module or the like that is executed by a command from a CPU or the like, for example.

### <Operation of Straddle-Type Vehicle Information Processor>

A description will be made on an operation of the straddle-type vehicle information processor according to the embodiment.

The following description will be made on a case where the physical quantity set s configured to include two types of physical quantities x1, x2 is acquired in a travel state information acquisition step. However, in the travel state information acquisition step, the physical quantity set s that is configured to include three types or more of the physical quantities may be acquired, and the Mahalanobis distance MHD may be derived with respect to such a physical quantity set s.

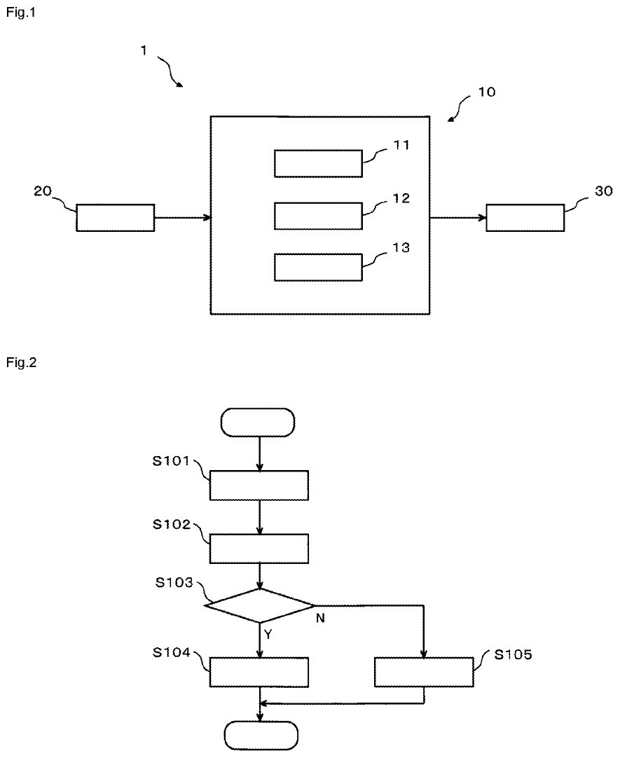

FIG. 2 is a flowchart of an exemplary operation of the straddle-type vehicle information processor according to the embodiment of the present invention.

The straddle-type vehicle information processor 10 repeatedly executes step S101 to step S105 illustrated in FIG. 2 when the straddle-type vehicle 1 is in the travel state.

### (Travel State Information Acquisition Step)

In step S101, the travel state information acquisition section 11 acquires, as the information related to the travel state of the straddle-type vehicle 1, the two types of the physical quantities x1, x2 at the time point. That is, the travel state information acquisition section 11 acquires the physical quantity set s at the time point. Each of the two types of the physical quantities x1, x2 may be raw data (that is, unprocessed data) that is detected by the travel state information sensor 20, or may be data that is acquired by eliminating noise from the raw data (that is, the unprocessed data) detected by the travel state information sensor 20.

In particular, each of the physical quantities x1, x2 is preferably data that is acquired by treating the raw data (that is, the unprocessed data) detected by the travel state information sensor 20 with a median filter. The median filter is used to replace the raw data (that is, the unprocessed data) acquired at a certain time point to the raw data (that is, the unprocessed data), a magnitude of which is ranked in the middle in a group of the raw data (that is, the unprocessed data) acquired in a specified period before and after the certain time point. Various types of the noise can be eliminated by appropriately setting duration of the specified period before and after the certain time point.

### (Crash Recognition Step)

Next, in step S102, the crash recognition section 12 acquires the Mahalanobis distance MHD with respect to the referred sample group of the physical quantity set s acquired in step S101. The crash recognition section 12 may derive the Mahalanobis distance MHD by calculation, or may derive the Mahalanobis distance MHD by referring to a lookup table that is created in advance, or the like.

More specifically, the Mahalanobis distance MHD is derived as a value that is calculated by the following equation 1. Note that x1, x2 in the equation 1 are the physical quantities x1, x2 of the physical quantity set s acquired in step S101. In addition, μ1 in the equation 1 is an average of a physical quantity X1 (a referred value of the same type of the physical quantity as the physical quantity x1) of the plural referred physical quantity sets S that constitute the referred sample group. Furthermore, μ2 in the equation 1 is an average of a physical quantity X2 (a referred value of the same type of the physical quantity as the physical quantity x2) of the plural referred physical quantity sets S that constitute the referred sample group. Moreover, Σ in the equation 1 is a covariance matrix of the physical quantities X1, X2 of the plural referred physical quantity sets S that constitute the referred sample group.

$$MHD = {\{ {( ( \begin{matrix}x 1 \\ x 2\end{matrix} ) - ( \begin{matrix}μ 1 \\ μ 2\end{matrix} ) )}^{T} {\sum }^{- 1} ( ( \begin{matrix}x 1 \\ x 2\end{matrix} ) - ( \begin{matrix}μ 1 \\ μ 2\end{matrix} ) ) \}}^{1 / 2} \qquad [ Equation 1 ]$$

Next, in step S103, the crash recognition section 12 determines whether the derived Mahalanobis distance MHD exceeds the reference value Th. If the Mahalanobis distance MHD exceeds the reference value Th, the processing proceeds to step S104. If the Mahalanobis distance MHD does not exceed the reference value Th, the processing proceeds to step S105. Note that the reference value Th may be a constant value or may be a variation value. In addition, the crash recognition section 12 may determine whether a change rate of the Mahalanobis distance MHD exceeds the reference value Th, or may determine whether a time in which the Mahalanobis distance MHD keeps exceeding the reference value Th exceeds a reference time.

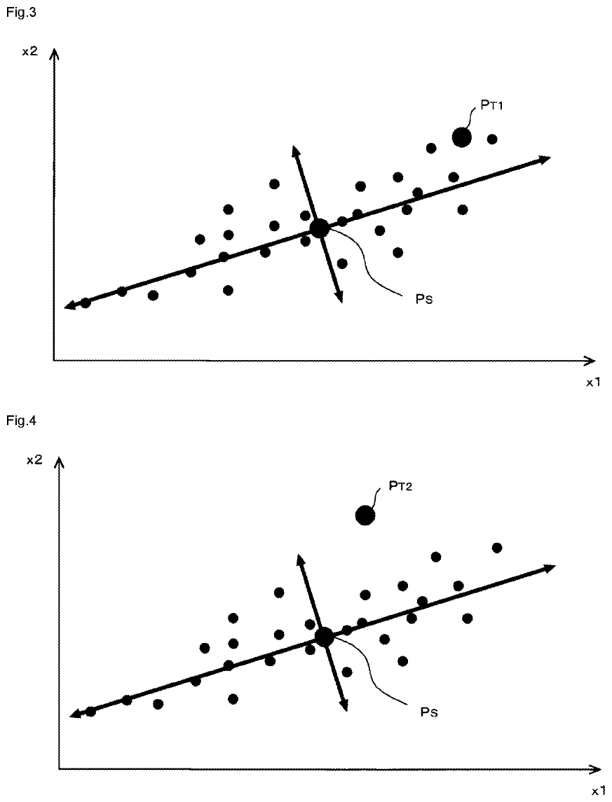

Each of FIG. 3 and FIG. 4 is a graph illustrating action in the crash recognition step that is executed by the crash recognition section of the straddle-type vehicle information processor according to the embodiment of the present invention.

Note that, in FIG. 3 and FIG. 4, a horizontal axis represents the physical quantity x1, and a vertical axis represents the physical quantity x2. In addition, in FIG. 3 and FIG. 4, a coordinate of each of the referred physical quantity sets S, which constitute the referred sample group, is plotted using a small dot, and an average coordinate Ps of all of the referred physical quantity sets S, which constitute the referred sample group, is dotted using a large dot. Furthermore, in FIG. 3, a coordinate P_{T1} of a physical quantity set s1 that is acquired at a time point T1 is plotted using a large dot, and in FIG. 4, a coordinate P_{T2} of a physical quantity set s2 that is acquired at a time point T2 is plotted using a large dot.

In an example illustrated in FIG. 3, the physical quantity set s1 (that is, the coordinate P_{T1}) that significantly deviates from the average coordinate Ps is acquired. However, since the deviation of the physical quantity set s1 from the referred sample group is insignificant, the short Mahalanobis distance MHD is derived, and it is thus determined that the crash has not occurred. Meanwhile, in the example illustrated in FIG. 4, compared to the example illustrated in FIG. 3, the physical quantity set s2 (that is, the coordinate P_{T2}) that slightly deviates from the average coordinate P_{S} is acquired. However, since the deviation of the physical quantity set s2 from the referred sample group is significant, the long Mahalanobis distance MHD is derived, and it is thus determined that the crash has occurred. That is, the crash recognition section 12 can determine whether the crash has occurred in consideration of dispersion states of the two types of the physical quantities x1, x2 in a no-crash state.

Note that the crash recognition section 12 may vary the referred sample group in accordance with the travel state of the straddle-type vehicle 1. For example, the crash recognition section 12 may change the referred sample group, which is used to derive the Mahalanobis distance MHD, in accordance with a speed, the acceleration, a bank angle, vibrations, or the like generated in the straddle-type vehicle 1.

The travel state information acquisition section 11 may further acquire another physical quantity set s that has a different combination of the types of the physical quantities from the physical quantity set s and that is configured to include at least two types of the physical quantities, and the crash recognition section 12 may switch the physical quantity set s to the other physical quantity set s in accordance with the travel state of the straddle-type vehicle 1, so as to derive the Mahalanobis distance MHD. That is, in the case where the travel state information acquisition section 11 acquires the three types of the angular velocity and the three types of the acceleration (that is, the six types of the physical quantities) generated in the straddle-type vehicle 1 during the travel from the travel state information sensor 20, the crash recognition section 12 may switch the physical quantities, each of which is selected to constitute the physical quantity set s, in accordance with the speed, the acceleration, the bank angle, the vibrations, or the like generated in the straddle-type vehicle 1.

### (Output Step)

Next, in step S104, the output section 13 outputs the trigger signal to the execution device 30. Meanwhile, in step S105, the output section 13 does not output the trigger signal to the execution device 30.

### <Effects of Straddle-Type Vehicle Information Processor>

A description will be made on effects of the straddle-type vehicle information processor according to the embodiment.

In the straddle-type vehicle information processor 10, the travel state information acquisition section 11 acquires, as the information related to the travel state of the straddle-type vehicle 1, the physical quantity set s, which is configured to include the at least two types of the physical quantities (x1, x2), and the crash recognition section 12 acquires the Mahalanobis distance MEM with respect to the referred sample group of the physical quantity set s and determines whether the crash has occurred on the basis of the relationship between the Mahalanobis distance MHD and the reference value Th. That is, it is determined whether the crash has occurred in consideration of the dispersion states of the at least two types of the physical quantities (x1, x2) in the no-crash state. Accordingly, even in the case where the acceleration of the straddle-type vehicle 1 is abruptly increased during the travel, such erroneous recognition that the straddle-type vehicle 1 has crashed can be prevented. In addition, it is possible to recognize that the straddle-type vehicle 1 has crashed at a stage before the acceleration is extremely increased. Therefore, the present invention can contribute to improvement in the occupant safety.

Preferably, the physical quantity set s includes the acceleration or the angular velocity generated in the straddle-type vehicle 1. With such a configuration, it is possible to accurately determine whether the crash has occurred. Therefore, it is possible to recognize that the straddle-type vehicle 1 has crashed during the travel with a high degree of accuracy at appropriate timing to contribute to the improvement in the occupant safety, and realization of such recognition is improved.

Preferably, the crash recognition section 12 varies the referred sample group in accordance with the travel state of the straddle-type vehicle 1. With such a configuration, it is possible to optimize the determination on whether the crash has occurred in accordance with vehicle body behavior. In particular, compared to a vehicle such as an automobile or a track, the vehicle body behavior of the straddle-type vehicle 1 is changed drastically. Therefore, such a configuration is particularly advantageous for the straddle-type vehicle 1.

Preferably, the travel state information acquisition section 11 further acquires, as the information related to the travel state of the straddle-type vehicle 1, the other physical quantity set s, which is configured to include the at least two types of the physical quantities, the physical quantity set s and the other physical quantity set s have the different combinations of the types of the physical quantities from each other, and the crash recognition section 12 switches the physical quantity set s, which is used to determine whether the crash has occurred, to the other physical quantity set s in accordance with the travel state of the straddle-type vehicle 1. With such a configuration, it is possible to optimize the determination on whether the crash has occurred in accordance with the vehicle body behavior. In particular, compared to the vehicle such as the automobile or the track, the vehicle body behavior of the straddle-type vehicle 1 is changed drastically. Therefore, such a configuration is particularly advantageous for the straddle-type vehicle 1.

Preferably, the at least two types of the physical quantities (x1, x2) acquired by the travel state information acquisition section 11 are treated with the median filter. Compared to other filters (for example, a moving average filter, a high-pass filter, a low-pass filter, a bandpass filter, and the like), use of the median filter can suppress a delay occurred to the data that has been processed using the filter. Therefore, it is possible to recognize that the straddle-type vehicle 1 has crashed during the travel with the high degree of accuracy at the appropriate timing to contribute to the improvement in the occupant safety, and the realization of such recognition is improved by using the median filter.

Preferably, the straddle-type vehicle 1 is the two-wheeled motor vehicle. Since travel stability and the occupant safety of the two-wheeled motor vehicle are especially low, the characteristics thereof that have been described so far are particularly effective in the two-wheeled motor vehicle.

### <Application Example of Operation of Straddle-Type Vehicle Information Processor>

In the description that has been made so far, the crash recognition section 12 recognizes that the straddle-type vehicle 1 has crashed during the travel only on the basis of the relationship between the Mahalanobis distance MEM, which is derived with respect to the physical quantity set s, and the reference value Th. The travel state information acquisition section 11 may further acquire, as the information related to the travel state of the straddle-type vehicle 1, a sub-physical quantity set ss that has a different combination of the types of the physical quantities from the physical quantity set s and is configured to include at least the two types of the physical quantities. The crash recognition section 12 may further acquire a sub-Mahalanobis distance MHDs that is the Mahalanobis distance with respect to a referred sample group of the sub-physical quantity set ss. That is, the crash recognition section 12 may make the determination on whether the straddle-type vehicle 1 has crashed during the travel on the basis of the relationship between the Mahalanobis distance MHD, which is derived with respect to the physical quantity set s, and the reference value Th and the determination on whether the straddle-type vehicle 1 has crashed during the travel on the basis of a relationship between the sub-Mahalanobis distance MHDs, which is derived with respect to the sub-physical quantity set ss, and a reference value Ths in parallel (that is, almost simultaneously). In this way, the crash recognition section 12 may recognize that the straddle-type vehicle 1 has crashed during the travel. With such a configuration, a response speed to the crash can be improved by making the high-sensitive determination while erroneous recognition of the crash by the low-sensitive determination is suppressed.

The description has been made so far on the embodiment. However, the present invention is not limited to the description of the embodiment. For example, only a part of the embodiment may be implemented, or parts of the embodiment may be combined.

### REFERENCE SIGNS LIST

1: Straddle-type vehicle
10: Straddle-type vehicle information processor
11: Travel state information acquisition section
12: Crash recognition section
13: Output section
20: Travel state information sensor
30: Execution device
x1, x2: Physical quantity
P_{S}: Average coordinate of referred sample group
P_{T1}: Coordinate of physical quantity set s1 acquired at time point T1
P_{T2}: Coordinate of physical quantity set s2 acquired at time point T2

1. A straddle-type vehicle information processor (10) comprising:
a travel state information acquisition section (11) that acquires information related to a travel state of a straddle-type vehicle (1);
a crash recognition section (12) that recognizes that the straddle-type vehicle (1) has crashed during travel on the basis of the information acquired by the travel state information acquisition section (11); and
an output section (13) that makes output corresponding to the recognition of the crash by the crash recognition section (12), wherein
the travel state information acquisition section (11) acquires, as the information, a physical quantity set (s) that is configured to include at least two types of physical quantities (x1, x2), and
the crash recognition section (12) acquires a Mahalanobis distance (MHD) with respect to a referred sample group of the physical quantity set (s), which is acquired by the travel state information acquisition section (11), and determines whether the crash has occurred on the basis of a relationship between said Mahalanobis distance (MHD) and a reference value (Th).

2. The straddle-type vehicle information processor according to claim 1, wherein
the physical quantity set (s) includes acceleration generated in the straddle-type vehicle (1).

3. The straddle-type vehicle information processor according to claim, wherein
the physical quantity set (s) includes an angular velocity generated in the straddle-type vehicle (1).

4. The straddle-type vehicle information processor according to claim 1, wherein
the crash recognition section (12) varies the referred sample group in accordance with the travel state of the straddle-type vehicle (1).

5. The straddle-type vehicle information processor according to claim 1, wherein
the travel state information acquisition section (11) further acquires, as the information, another physical quantity set (s) that is configured to include at least two types of the physical quantities,
the physical quantity set (s) and the other physical quantity set (s) have different combinations of the types of the physical quantities from each other, and
the crash recognition section (12) switches the physical quantity set (s), which is used to determine whether the crash has occurred, to the other physical quantity set (s) in accordance with the travel state of the straddle-type vehicle (1).

6. The straddle-type vehicle information processor according to claim 1, wherein
the travel state information acquisition section (11) further acquires, as the information, a sub-physical quantity set (ss) that is configured to include at least two types of the physical quantities,
the physical quantity set (s) and the sub-physical quantity set (ss) have different combinations of the types of the physical quantities from each other, and
the crash recognition section (12)
further acquires a sub-Mahalanobis distance (MHDs) that is the Mahalanobis distance with respect to a referred sample group of the sub-physical quantity set (ss) acquired by the travel state information acquisition section (11), and determines whether the crash has occurred on the basis of a relationship between said sub-Mahalanobis distance (MHDs) and a reference value (Ths), and
makes the determination on the basis of the relationship between the Mahalanobis distance (MHD) and the reference value (Th) and the determination on the basis of the relationship between the sub-Mahalanobis distance (MHDs) and the reference value (Ths) in parallel, so as to recognize that the straddle-type vehicle (1) has crashed during the travel.

7. The straddle-type vehicle information processor according to claim 1, wherein
the at least two types of the physical quantities (x1, x2) acquired by the travel state information acquisition section (11) are treated with a median filter.

8. The straddle-type vehicle information processor according to claim 1, wherein
the straddle-type vehicle (1) is a two-wheeled motor vehicle.

9. A straddle-type vehicle information processing method comprising:
a travel state information acquisition step (S101) of acquiring information related to a travel state of a straddle-type vehicle (1);
a crash recognition step (S102, S103) of recognizing that the straddle-type vehicle (1) has crashed during travel on the basis of the information acquired in the travel state information acquisition step (S101); and
an output step (S104, S105) of making output corresponding to the recognition of the crash in the crash recognition step (S102, S103), wherein
in the travel state information acquisition step (S101), a physical quantity set (s) that is configured to include at least two types of physical quantities (x1, X2) is acquired as the information, and
in the crash recognition step (S102, S103), a Mahalanobis distance (MHD) is acquired with respect to a referred sample group of the physical quantity set (s) acquired in the travel state information acquisition step (S101), and it is determined whether the crash has occurred on the basis of a relationship between said Mahalanobis distance (MHD) and a reference value (Th).
